(19) United States
(12) Patent Application Publication
(10) Pub. No.: US 2016/0086037 A1
(43) Pub. Date: Mar. 24, 2016

(54) THEMATIC RECOMMENDATIONS

(71) Applicant: KT CORPORATION, Seongnam-si (KR)

(72) Inventors: Ji-Hui IM, Seoul (KR); Du-seong CHANG, Anyang-si (KR); Hyungkeun KOO, Seoul (KR); Joo-won SUNG, Seoul (KR)

(21) Appl. No.: 14/837,092

(22) Filed: Aug. 27, 2015

(30) Foreign Application Priority Data
Sep. 23, 2014 (KR) 10-2014-0126752

(51) Int. Cl. G06K 9/00; H04N 21/466

(52) U.S. Cl. CPC G06K 9/00718; H04N 21/4668

(57) ABSTRACT

In one example, a content theme recommendation system may include a content recommendation server configured to: generate a plurality of themes with respect to multiple contents, calculate similarities between the plurality of themes, collect content viewing logs for one or more of the multiple contents from a user device, convert the content viewing logs into theme viewing logs based on metadata for the plurality of themes, and provide one or more recommended theme to the user device based on the theme viewing logs and the similarities between the plurality of themes; and the user device configured to receive one or more recommended theme from the content recommendation server.

### TECHNICAL FIELD

The embodiments described herein pertain generally to video content recommendations.

### BACKGROUND

Services and/or applications for recommending video content for a user first observe the user's video content preferences and/or viewing patterns in order to provide video content recommendations. The recommendations may be presented in the form of a list, typically in ascending or descending order based on the observed video content preferences and/or viewing patterns. The user then searches the list using a scrolling function or by inserting keywords into a search box. Current services are high-level and are, seemingly, non-customized to the particular user.

### SUMMARY

In one example embodiment, a method to implement content recommendations includes generating a plurality of themes with respect to multiple contents, calculating similarities between the plurality of themes, collecting content viewing logs for one or more of the multiple contents from a user device, converting the content viewing logs into theme viewing logs based on metadata for the plurality of themes, and providing one or more recommended theme to the user device based on the theme viewing logs and the similarities between the plurality of themes.

In another example embodiment, a server includes a theme generator configured to generate a plurality of themes with respect to various media content, a comparator configured to calculate similarities between the plurality of themes, a log collector configured to collect content viewing logs for one or more of the multiple contents from a user device, a converter configured to convert the content viewing logs into theme viewing logs based on metadata for the plurality of themes, and a recommended theme provider configured to provide one or more recommended theme to the user device based on the theme viewing logs and the similarities between the plurality of themes.

In yet another example embodiment, a content theme recommendation system may include a content recommendation server configured to: generate a plurality of themes with respect to multiple contents, calculate similarities between the plurality of themes, collect content viewing logs for one or more of the multiple contents from a user device, convert the content viewing logs into theme viewing logs based on metadata for the plurality of themes, and provide one or more recommended theme to the user device based on the theme viewing logs and the similarities between the plurality of themes; and the user device configured to receive one or more recommended theme from the content recommendation server.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of thematic recommendations may be implemented, arranged in accordance with one or more embodiments described herein;

FIG. 2 shows an example configuration of an apparatus by which at least portions of thematic recommendations may be implemented, arranged in accordance with one or more embodiments described herein;

FIG. 3 shows an example processing flow of operations for implementing at least portions of thematic recommendations, arranged in accordance with one or more embodiments described herein;

FIG. 4 shows another example processing flow of operations for implementing at least portions of thematic recommendations, arranged in accordance with one or more embodiments described herein;

FIG. 5 shows an example computing device on which and by which at least portions of thematic recommendations may be implemented, arranged in accordance with one or more embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Further, as referenced herein, an application domain may be regarded as a construct within an execution environment that is a unit of isolation for a process. More particularly, the isolation construct may enable the code executed therein to be loaded from a specified source; the isolation construct may be aborted independent of other such isolation constructs; and processing within the isolation construct may be isolated so that a fault occurring therein does not affect other isolation constructs within the process. In other words, the effects of processing within an isolation construct are not visible to concurrently-running constructs until the overall process is made permanent. Further, for the sake of consistency, the discussion of thematic recommendations hereafter refers to “applications” and “processes,” both of which may encompass any one of, at least, software programs, and applications, either singularly or in combination.

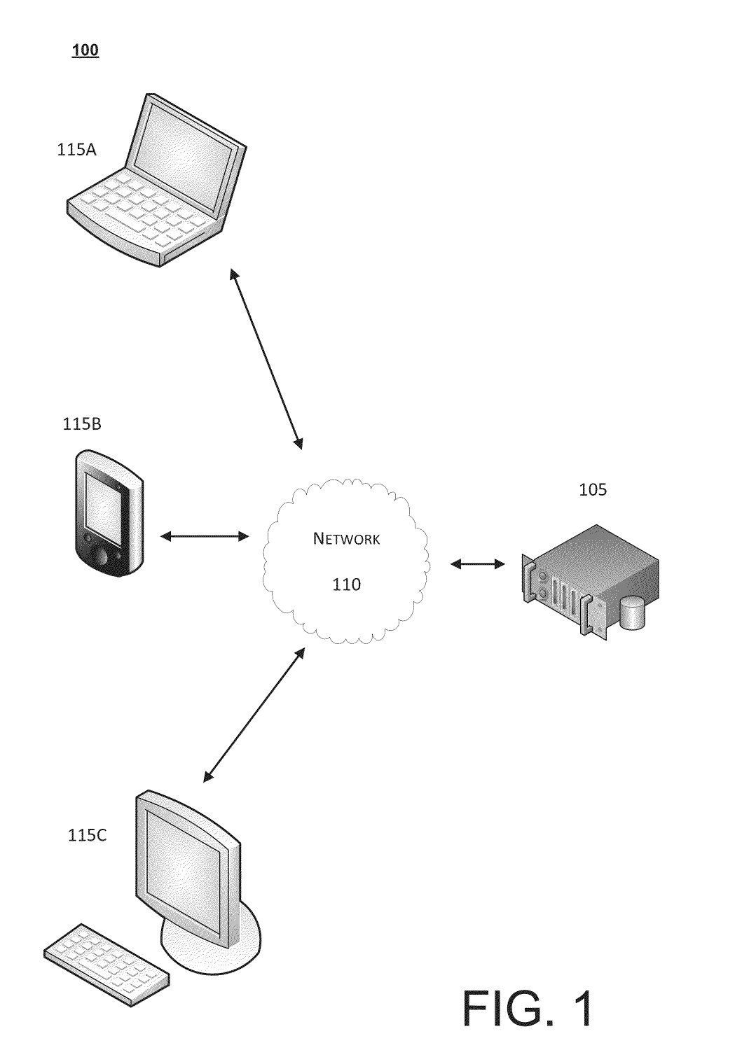

FIG. 1 shows an example system configuration in which one or more embodiments of thematic recommendations may be implemented. As depicted, configuration 100 includes, at least, a server 105; a network 110; and client devices 115A, 115B, and 115C. Unless context requires specific reference to a particular one of client devices 115A, 115B, and 115C, reference herein may be made to a singular embodiment of client device 115 or, alternatively, reference herein may be made to the collective client devices 115.

Server 105 may be a computing device configured, programmed, and/or designed to generate and provide a user with thematic video content recommendations based on criteria, as described below. Server 105 may be configured as, as examples only, an application server, a standalone server, a web server, and any other devices being capable of, at least, receiving data signals and/or files, identifying and processing the received data signals/and/or files, and transmitting the processed signals and/or data.

Server 105 may be configured, programmed, and/or designed to generate video content themes corresponding to respective to video content, calculate similarities between the respective themes, collect video content viewing logs for at least some of the video content from a user device, convert the video content viewing logs into theme viewing logs based on metadata for the respective themes, and provide one or more recommended themes to the user device based on the theme viewing logs and the similarities between the plurality of themes.

Network 110 may include, but is not limited to, a computer network, an internet, a telephone network, a TCT/IP data network (wide area networks, metropolitan area networks, local area networks, campus area networks, virtual private networks), and any other processing and/or computing devices capable of providing at least server-to-client communications.

Client devices 115 may refer to an electronic device that is configured to transmit and receive digital messages over a wired or wireless communication network provided by a service provider, the digital messages data that indicates, as non-limiting examples, video content viewing preferences and/or patterns for a user of the respective device. Such video content viewing preferences and/or patterns are described, in varying permutations, below. Client device 115A may also be implemented as a personal computer including tablet, laptop computer; client device 115C may be implemented in a non-laptop configuration. In addition, or alternatively, client device 115B may be implemented as a portion of a small-form factor portable (or mobile) electronic device such as a mobile phone, cell phone, smartphone, personal data assistant (PDA), a personal media player device, an application specific device, or a hybrid device that include any of the above functions.

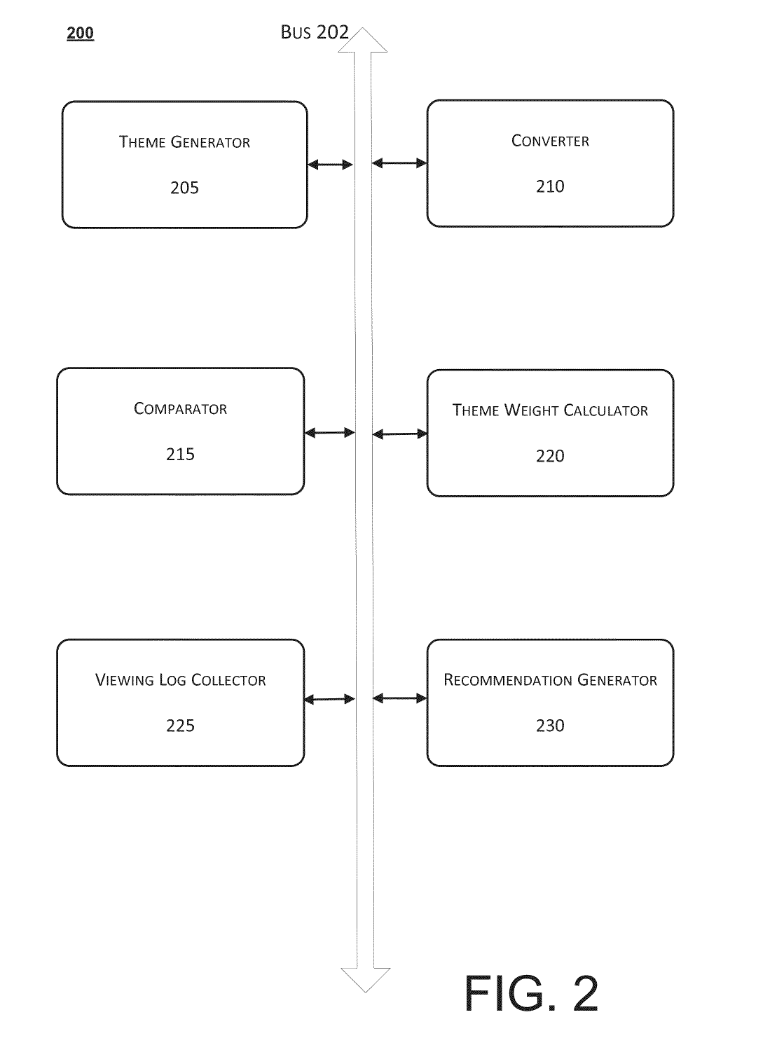

FIG. 2 shows an example configuration of an apparatus 200, by which at least portions of thematic recommendations may be implemented. Apparatus 200 may be hosted and implemented, at least in part, by at least server 105. Apparatus 200 may include, but not be limited to, theme generator 205, converter 210, comparator 215, theme weight calculator 220, log collector 225, and recommendation generator 230. These components may be implemented in a computing environment relative to either or both server 105 and one or more of client devices 115, and may be stored in a corresponding memory storage device. By way of example, apparatus 200, which may also be considered to be a programmable application, may reside on a memory device of either of server 105 and one or more of client devices 115. For purposes of illustration, the application or program, including executable program components, are illustrated herein as discrete blocks, although it is recognized that such programs and components reside at various times in different storage components of the corresponding client device, and may be executed by at least one data processor of the computer.

Theme generator 205 may refer to a module or component that is designed, programmed, and/or configured to, e.g., generate a plurality of themes with respect to multiple video/media content offerings. For example, theme generator 205 may generate themes using sentiment analysis based on subjective data that may be associated with the respective media content offerings via, e.g., social media network sources, user comments, user rankings, and other online content sources. Sentiment analysis (also known as opinion mining) refers to the use of natural language processing, text analysis and computational linguistics to identify and extract subjective information in source materials. In addition, or alternatively, theme generator 205 may generate the plurality of themes based on metadata for the multiple video/media content offerings that is stored in a database or searched from web.

As referenced herein, a media offering may be a file, of any format that may be streamed via network 110, which includes media content. A media file may be in any video and/or audio format that is capable of such streaming. Such media files may include, but not be limited to, television content, both one-time events and episodic series, theatrical releases (movies, documentaries, etc.), televised sporting events, etc. Further, server 105, and thus apparatus 200, may be hosted and/or implemented by a media content service provider that provides subscribers or one-off customers with media content, typically but not always for a service fee. Thus, reference to “televised” content may also apply to media content that is streamed. Subscribers and one-off customers may purchase one or more media offerings from a media content service provider for short-term, e.g., one week or 5 viewings, or for permanent use though for a higher fee.

Converter 210 may refer to a module or component that is designed, programmed, and/or configured to calculate similarities between two or more of the generated themes for at least some of the video/media content offerings.

Comparator 215 may refer to a module or component that is designed, programmed, and/or configured to compare the generated themes to determine one or more similarities that may exist amongst them. The similarities may be based on direct comparisons between two of the compared themes or a listing of similar characteristics and/or features of the respective themes may be compiled with respect to two or more of the themes.

As referenced herein, the similarities calculated or determined to exist between two or more of the generated themes may pertain to characteristics and/or features derived or gleaned from metadata extracted from the respective video/media content offerings. Thus, the themes, and hence the similarities, may correspond to objective data including, but not limited to, genre, names of actors, names of directors, names of generating studios, year of release or first airing, names of athletes, names of athletic teams, date of event, etc. The themes, and hence similarities, may also correspond to subjective data that may be associated with the respective media content offerings via, e.g., social media network sources, user comments, user rankings, and other online content sources. Thus, themes may be based on social commentary.

Theme weight calculator 220 may refer to a module or component that is designed, programmed, and/or configured to calculate or otherwise determine a weighted value of a respective one of the generated themes based on, e.g., a quantity of the video/media content offerings corresponding to a respective theme and user feedback, e.g., comments, ratings, ranking, for the respective video/media content offerings.

Viewing log collector 225 may refer to a module or component that is designed, programmed, and/or configured to log viewing data, or to receive such data, pertaining to the respective video/media content offerings. Such viewing data, for a respective subscriber/user, may include various permutations of how many times the respective subscriber/user viewed the respective video/media content offering; the times at which the respective subscriber/user viewed the respective video/media content offering, including but not limited to a day of week, time of day; how many episodes of respective video/media content offerings that the respective subscriber/user viewed; how much of the respective video/media content offerings that the respective subscriber/user actually viewed; etc. The viewing data may correspond to one of client devices 115 that corresponds to a respective subscriber/user as indicated in, e.g., subscription information, or correspond to any one of client devices 115 on which a respective subscriber/user logs in based on, e.g., subscription information.

Recommendation generator 230 may refer to a module or component that is designed, programmed, and/or configured to provide one or more recommended themes to any one of client devices 115 corresponding to a respective user indicated by, e.g., subscription information, based on a correspondence of one or more of the logged viewing data for the respective user and similarities determined among the themes corresponding to the respective video/media content offerings.

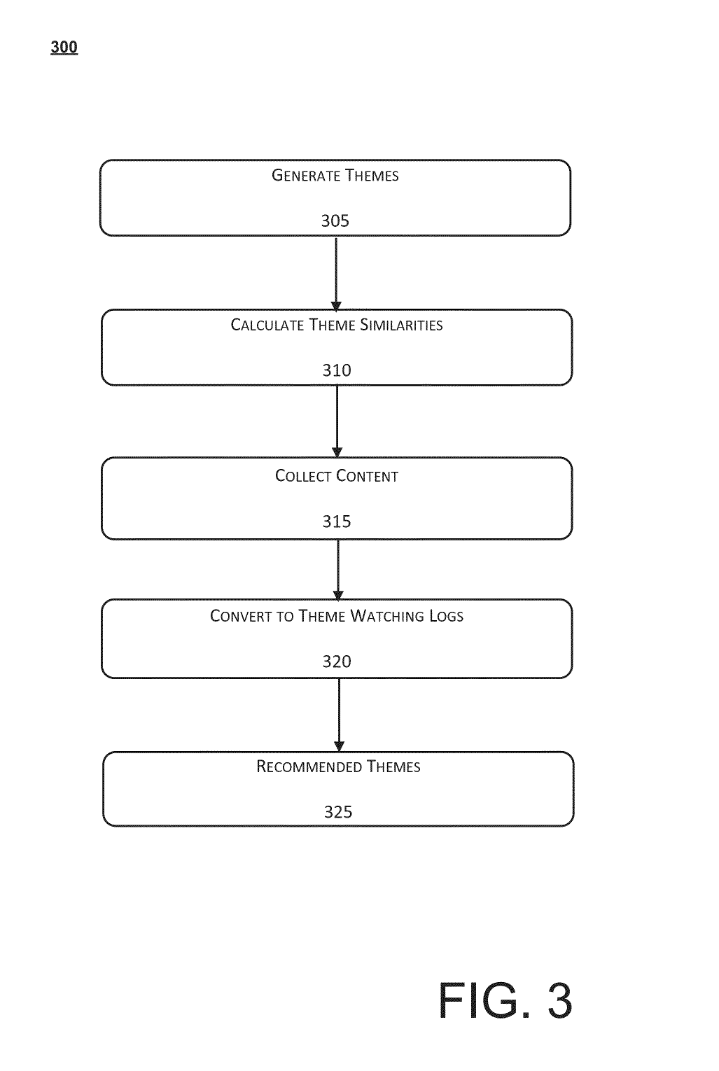

FIG. 3 shows an example processing flow 300 of operations for implementing at least portions of thematic recommendations. Process 300 may be implemented by any of the embodiments, or components thereof, referenced previously regarding FIGS. 1 and 2. Further, example process 300 may include one or more operations, actions, or functions as illustrated by one or more blocks 305, 310, 315, 320, and 325. Although illustrated as discrete blocks, various blocks may be divided into additional blocks, combined into fewer blocks, or eliminated, depending on the desired implementation.

Processing flow 300 may be implemented to generate a plurality of themes with respect to multiple video/media content offerings for a user of any one of client devices 115. Processing may begin at block 305.

Block 305 (Generate Themes) may refer to theme generator 205 generating a plurality of themes with respect to multiple video/media content offerings.

Themes may be generated in various forms including, but not limited to, descriptive words, phrases, or sentences with the intent to characterize the respective video/media content offerings. A theme may be generated using, singularly or in combination, meta data corresponding to the respective video/media content offerings, e.g., genre, names of actors, names of directors, names of generating studios, year of release or first airing, names of athletes, names of athletic teams, date of event, etc. The themes may also be generated using subjective data that may be associated with the respective media content offerings via, e.g., social media network sources, user comments, user rankings, and other online content sources. That is, themes may be based on social commentary provided by a user of any one of client devices 115 who subscribes to a service provider that provides the various video/media content offerings.

In that regard, theme generator 205 may extract the subscriber's commentary, rankings, etc., from online news sources or social networking services for respective video/media content offerings. Such extracted commentary may include key words, phrases, and/or sentences that express the user's stated preferences, viewing patterns, and data from the user's subscription profile. Thus, themes may be grouped corresponding to respective subscribers and even one-off customers.

Block 305 may further refer to theme generator 204 compiling respective video/media content offerings based on one or more themes for each respective offering. Thus, each respective video/media content offering may be listed for one or more themes. Block 305 may be followed by block 310.

Block 310 (Calculate Theme Similarities) may refer to comparator 215 comparing the generated themes to determine one or more existing similarities. The similarities may be based on direct comparisons between two of the compared themes or a listing of similar characteristics and/or features of the respective themes may be compiled with respect to two or more of the themes.

As referenced herein, the similarities calculated or determined to exist between two or more of the generated themes may pertain to characteristics and/or features derived or gleaned from metadata extracted from the respective video/media content offerings. Thus, the themes, and hence the similarities, may correspond to objective data including, but not limited to, genre, names of actors, names of directors, names of generating studios, year of release or first airing, names of athletes, names of athletic teams, date of event, etc. The themes, and hence similarities, may also correspond to subjective data that may be associated with the respective video/media content offerings via, e.g., social media network sources, user comments, user rankings, and other online content sources.

Block 310 may further refer to theme weight calculator 220 calculating or otherwise determining a weighted value of a respective one of the generated themes based on, e.g., a quantity of the video/media content offerings corresponding to a respective theme and user feedback, e.g., comments, ratings, ranking, for the respective video/media content offerings. Block 310 may be followed by block 315.

Block 315 (Collect Content) may refer to viewing log collector 225 collecting viewing logs from client devices 115 corresponding to a subscriber/user, the viewing log including data pertaining to respective video/media content offerings. The collected viewing log(s), for a respective subscriber/user, may include various permutations of how many times the respective subscriber/user viewed the respective video/media content offering; the times at which the respective subscriber/user viewed the respective video/media content offering, including but not limited to a day of week, time of day; how many episodes of respective video/media content offerings that the respective subscriber/user viewed; how much of the respective video/media content offerings that the respective subscriber/user actually viewed; etc. The viewing data may correspond to one of client devices 115 that corresponds to a respective subscriber/user as indicated in, e.g., subscription information, or correspond to any one of client devices 115 on which a respective user logs in based on, e.g., subscription information. Further, the system collects feedback from the respective subscriber/user with regard to favorability or a ranking for each of the video/media content offerings. Block 315 may be followed by block 320.

Block 320 (Convert to Theme Viewing Logs) may refer to theme weight calculator 225 cross-referencing the weighted values for respective ones of the generated themes with the collected viewing logs from client devices 115 corresponding to a subscriber/user. Accordingly, block 320 may refer to theme weight collector generating a theme or thematic viewing log for the subscriber/user. Block 320 may be followed by block 325.

Block 325 (Recommend Themes) may refer to recommendation generator 220 calculating a probability similarity for one or more of the generated themes; and, based on a comparison of the objective, e.g., metadata, and subjective data utilized to generate the respective themes, determine similarities in respective video/media content offerings for the generated themes. That is, recommendation generator 220 may utilize the video/media content offering viewing logs into video/media content theme viewing logs. Based on the determined similarities for the respective vide/media content offerings for the respective themes, recommendation generator 220 may further calculate similarities amongst the themes; and, further utilizing the video/media content theme viewing logs, determine one or more themes to recommend to the subscriber/user.

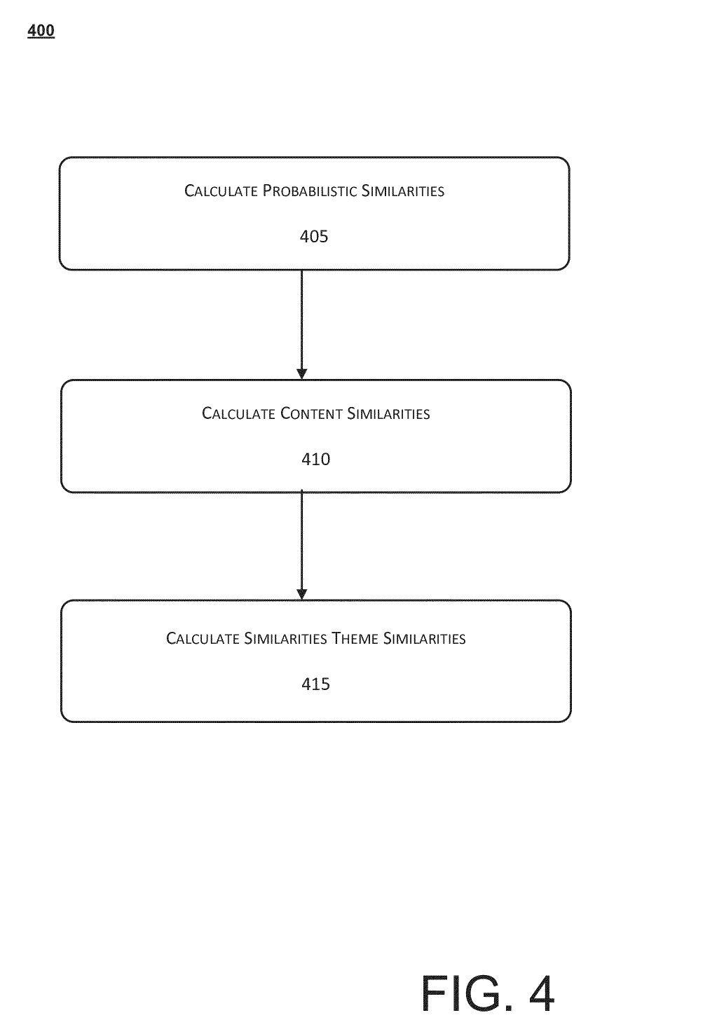

FIG. 4 shows another example processing flow 400 of operations for implementing at least portions of thematic recommendations. Process 400 may be implemented by any of the embodiments, or components thereof, referenced previously regarding FIGS. 1 and 2. Further, example process 400 may include one or more operations, actions, or functions as illustrated by one or more blocks 405, 410, and 415. Although illustrated as discrete blocks, various blocks may be divided into additional blocks, combined into fewer blocks, or eliminated, depending on the desired implementation. Processing may begin at block 405.

Block 405 (Calculate Probabilistic Similarities) may refer to comparator 215 calculating probabilistic similarities between one or more of the plurality of themes and the corresponding media/video content, based on the theme viewing logs. The probabilistic similarities may depend on user's viewing tendency of the media content offerings. Block 405 may be followed by block 410.

Block 405 may refer to comparator 215 calculating probabilistic the aforementioned similarities using collaborative filtering, based on user's contents/theme viewing logs and/or user's subjective data, e.g., reviews, rankings. etc., related to video contents offerings. The calculations may, additionally or alternatively, be based on another user's contents/theme viewing logs and/or the other user's subjective data related to video contents offerings. As referenced herein, “another user” may be a user who has viewed the same video/media contents offering(s) that the user has previously viewed; thus, “another user” may be a user having a similar viewing tendencies as the user.

For example, a theme that includes recommended content or content that has been viewed by another user may have a high probabilistic similarity because content that has been recommended by another user having similar viewing tendencies may have a high likelihood of being selected/viewed by the user.

Block 410 (Calculate Content Similarities) may refer to comparator 215 calculating similarities between content corresponding to the plurality of themes based on metadata for the plurality of themes or metadata for the media/video content offerings belonging to the corresponding theme. The content similarities may depend on correlation of content of the plurality of themes. Block 405 may be followed by block 410.

Block 410 may refer to comparator 215 calculating content similarities, using content-based filtering, based on metadata of the video contents offerings included each of the plurality of themes and metadata of content that the user has previously viewed. As set forth above, metadata may include, genre, names of actors, names of directors, names of generating studios, year of release or first airing, names of athletes, names of athletic teams, date of event, etc., pertaining to the video/media content offerings. For example, if viewing logs reveal that the user has a preference for action movies, a theme that includes contents related to action movies may be regarded as having a high content similarity.

Block 415 (Calculate Theme Similarities) may refer to comparator 215 comparing the calculated similarities between the plurality of themes based on the probabilistic similarities and the calculated similarities between content corresponding to the respective themes. By using the probabilistic similarities and the content similarities, the similarities between the plurality of themes may reflect both user's viewing tendency and the correlation of content of the plurality of themes.

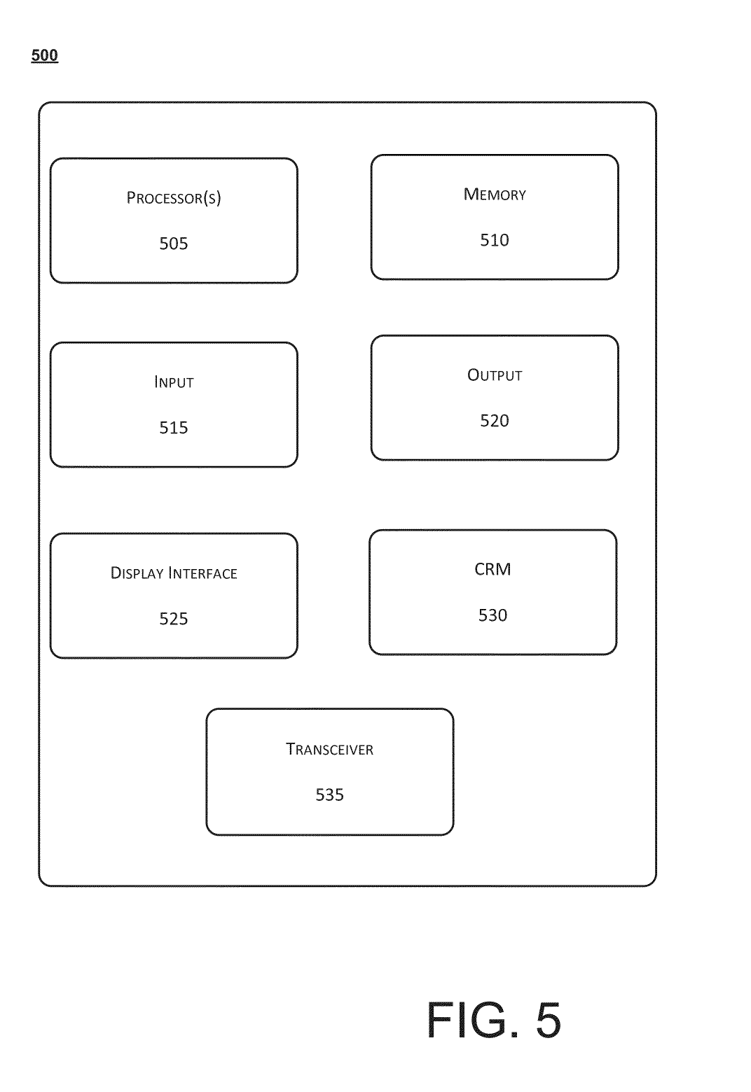

FIG. 5 shows an example computing device on which and by which at least portions of thematic recommendations may be implemented.

More particularly, FIG. 5 shows an illustrative computing embodiment, in which any of the processes and sub-processes of thematic recommendations may be implemented as computer-readable instructions stored on a computer-readable medium. The computer-readable instructions may, for example, be executed by a processor of any one of server 105 and/or client devices 115, as referenced herein, having a network element and/or any other device corresponding thereto, particularly as applicable to the applications and/or programs described above corresponding to the configuration 100 for transactional permissions.

In a very basic configuration, a computing device 500 may typically include, at least, one or more processors 505 and a system memory 510. Computing device 500 may also include one or more input components, one or more output components, a display component, a computer-readable medium, and a transceiver.

Processor(s) 505 may refer to, e.g., a microprocessor, a microcontroller, a digital signal processor, or any combination thereof.

Memory 510 may refer to, e.g., a volatile memory, non-volatile memory, or any combination thereof. Memory 510 may store, therein, an operating system, an application, and/or program data. That is, memory 510 may store executable instructions to implement any of the functions or operations described above and, therefore, memory 510 may be regarded as a computer-readable medium.

Input component 515 may refer to a built-in or communicatively coupled keyboard, touch screen, or telecommunication device. Further, an input component, if not built-in to computing device 500, may be communicatively coupled thereto via short-range communication protocols including, but not limited to, radio frequency or Bluetooth.

Output component 520 may refer to a component or module, which may be built-in or removable from computing device 500, which is configured to output data to an external device.

Display component 525 may refer to, e.g., a solid state display that may have touch input capabilities. That is, a display component may include capabilities that may be shared with or replace those of the aforementioned input components.

Computer-readable medium 530 may refer to a separable machine readable medium that is configured to store one or more programs that embody any of the functions or operations described above. That is, a computer-readable medium, which may be received into or otherwise connected to a drive component of computing device 500, may store executable instructions to implement any of the functions or operations described above. These instructions may be complimentary or otherwise independent of those stored by memory 510.

Transceiver 535 may refer to a network communication link for computing device 500, configured as a wired network or direct-wired connection. Alternatively, a transceiver may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A method performed by a content recommendation server, comprising:
generating a plurality of themes with respect to multiple video content offerings;
calculating similarities between each of the plurality of themes and corresponding content previously viewed on a user device;
collecting content viewing logs for one or more of the multiple video content offerings from the user device;
converting the content viewing logs into theme viewing logs based on metadata for the plurality of themes; and
providing one or more recommended theme to the user device based on the theme viewing logs and the similarities between the plurality of themes.

2. The method of claim 1, further comprising:
generating a content list for each of the plurality of themes; and
collecting feedback information on one or more of the multiple video content offerings from the user device.

3. The method of claim 2, further comprising:
calculating a theme weight based on the content list for each of the plurality of themes and the feedback information on one or more of the multiple video content offerings.

4. The method of claim 3, wherein the converting of the content viewing logs into the theme viewing logs is performed based on the theme weight.

5. The method of claim 1, wherein the calculating comprises:
calculating probabilistic similarities between each of the plurality of themes and the reference contents based on the theme viewing logs;
calculating content similarities between each of the plurality of themes and the reference contents based on the metadata for the plurality of themes; and
calculating the similarities between the plurality of themes based on the probabilistic similarities and the content similarities.

6. The method of claim 1, further comprising:
determining a ranking of contents included each of the one or more recommended theme based on at least one of a popularity of each video content offering, a degree of association of each video content offering with the one or more recommended theme, a user's tendency, reviews or whether the user device previously viewed each video content offering.

7. The method of claim 6, wherein the providing one or more recommended theme comprises:
providing one or more video content offering lists according to the ranking.

8. A server, comprising:
a theme generator configured to generate a plurality of themes with respect to multiple video content offerings;
a comparator configured to calculate similarities between each of the plurality of themes and reference contents including contents a user device previously viewed;
a log collector configured to collect content viewing logs for one or more of the multiple video content offerings from the user device;
a converter configured to convert the content viewing logs into theme viewing logs based on metadata for the plurality of themes; and
a recommended theme provider configured to provide one or more recommended theme to the user device based on the theme viewing logs and the similarities between the plurality of themes.

9. The server of claim 8, wherein the theme generator is further configured to generate a video content offerings list for each of the plurality of themes, and
the log collector is further configured to collect feedback information on one or more of the multiple video content offerings from the user device.

10. The server of claim 9, further comprising:
a theme weight calculator configured to calculate a theme weight based on the content list for each of the plurality of themes and the feedback information for one or more of the multiple video content offerings.

11. The server of claim 10, wherein the converter is further configured to convert the content viewing logs into the theme viewing logs based on the theme weight.

12. The server of claim 8, wherein the comparator further configured to calculate probabilistic similarities between each of the plurality of themes and the reference contents based on the theme viewing logs and content similarities between each of the plurality of themes and the reference contents based on the metadata for the plurality of themes.

13. The server of claim 12, wherein the comparator is further configured to calculate the similarities between the plurality of themes based on the probabilistic similarities and the content similarities.

14. The server of claim 8, wherein the theme generator is further configured to determine a ranking of video content offerings included each of the one or more recommended theme based on at least one of a popularity of each video content offering, a degree of association of each video content offering with the one or more recommended theme, a user's tendency, reviews or whether the user device previously viewed each video content offering.

15. The server of claim 14, wherein the theme provider is further configured to provide one or more video content offering list according to the ranking.

16. A system, comprising:
a video content offering recommendation server configured to:
generate a plurality of themes with respect to multiple video content offerings,
calculate similarities between each of the plurality of themes and reference contents including contents a user device previously viewe,
collect content viewing logs for one or more of the multiple video content offerings from the user device,
convert the content viewing logs into theme viewing logs based on metadata for the plurality of themes, and
provide one or more recommended theme to the user device based on the theme viewing logs and the similarities between the plurality of themes; and
wherein the user device is configured to receive one or more recommended themes from the video content offering recommendation server.

17. The system of claim 16, wherein the video content offering recommendation server is further configured to:
generate a video content offering list for each of the plurality of themes,
collect feedback information on one or more of the multiple video content offerings from the user device,
calculate a theme weight based on the video content offering list for each of the plurality of themes and the feedback information on one or more of the multiple video content offerings, and
convert the content viewing logs into the theme viewing logs based on the theme weight.

18. The system of claim 16, wherein the video content offering recommendation server is further configured to:
calculate probabilistic similarities between each of the plurality of themes and the reference contents based on the theme viewing logs,
calculate content similarities between each of the plurality of themes and the reference contents based on the metadata for the plurality of themes, and
calculate the similarities between the plurality of themes based on the probabilistic similarities and the content similarities.

19. The system of claim 16, wherein the video content offering recommendation server is further configured to:
determine a ranking of video content offerings included each of the one or more recommended themes based on at least one of a popularity of each video content offering, a degree of association of each video content offering with the one or more recommended themes, a user's tendency, reviews or whether the user device previously watched each content, and
provide one or more content list according to the ranking.
